(19) United States
(12) Patent Application Publication
(10) Pub. No.: US 2011/0083603 A1
(43) Pub. Date: Apr. 14, 2011

(54) CURTAIN COATER

(75) Inventors: Eduard Davydenko, Grefrath-Oedt (DE); Andreas Pesch, Krefeld (DE)

(73) Assignee: Andritz Kusters GmbH, Krefeld (DE)

(21) Appl. No.: 12/851,727

(22) Filed: Aug. 6, 2010

(30) Foreign Application Priority Data
Oct. 9, 2009 (DE) 102009048820.0

(51) Int. Cl. B05D 1/30

(52) U.S. Cl. 118/314

(57) ABSTRACT

Curtain coater for discharging coating medium in the form of a curtain moving substantially under the force of gravity onto a moving paper or board web, comprising a hopper (1), which has a cavity (7) extending along a discharge width, to which the coating medium is fed via at least two feed lines (12) which each have a device for adjusting the volume flow of coating medium fed in, and a flow channel (6) which discharges the coating medium via an outer slot as a curtain, wherein the flow channel (6) is broken down into a large number of individual widening guide channels (6.1 to 6.n) of a diffuser block which, on the inlet side, adjoin a cavity (7) subdivided along the discharge width, at least in some regions, into sections (7.1 to 7.n), each of these sections (7.1 to 7.n) being connected to a feed line (12) and having a pitch which spans a plurality of guide channels (6.1 to 6.n) of the diffuser block.

The invention relates to a curtain coater for discharging liquid or pasty coating medium in the form of a curtain or film moving substantially under the force of gravity onto a moving substrate, in particular of paper or board.

### BACKGROUND OF THE INVENTION

It is known from DE 100 57 733 A1 that such a curtain coater comprises a nozzle chamber to which the coating medium is fed via a feed line and which discharges the coating medium through an outlet opening as a curtain or film. In this case, the curtain coater is located at a distance from the substrate, which results in the advantage of non-contact application.

### BRIEF SUMMARY OF THE INVENTION

In order to form a curtain, the curtain coater (curtain applicator) can be used with a slot-fed type curtain die or a slide-fed type curtain die. In the case of a slot-fed type curtain die (slot-fed die) of a single-layer curtain coater, the curtain is formed directly at the outlet from the die gap. The curtain coaters having a slot die are known, for example, from DE 197 16 647 A1 and DE 10 2005 017 547 A1. The slide dies are used in multi-layer web coating. In the case of a slide die, the coating compound from a cavity first flows upwards to the outer slot. From the outer slot, the coating fluid runs onto an inclined plane, is overlaid there with the coating fluids from the upper layers and then led to the nozzle lip. The curtain is formed only at the outlet edge of the nozzle lip. The slide dies are described, for example, in WO 01/54828 A1 and WO 2005/024133 A1.

The distribution system of the nozzle is arranged above the moving paper web and is located between the nozzle lip and the paper web. The problem with the slide dies is that the space for the distribution system and for the nozzle is very limited by the curtain height, which is usually 100 to 250 mm.

During coating of the paper or board web with a curtain coater, the coating fluid is intended to be applied as uniformly as possible over the entire web width. The wet-film thickness must be as constant as possible over the entire web surface. However, it is difficult to achieve a uniformly thick coating medium curtain over the entire coating width, the greater the coating width is. High web speeds constitute a further high loading on the stability of the coating medium curtain, since the latter is stretched upon contact with the substrate, on account of the difference between the speed shortly before impingement on the substrate and the running speed of the moving substrate. In order to achieve a high-quality coating result, the uniformity of the coating medium curtain with which the latter leaves the outer slot of the discharge nozzle is therefore of great importance. This applies in particular when the coating medium is intended to be brought onto the substrate substantially in finally metered form, which means that it is a “1:1” application, and when, in addition, only very small quantities of coating medium are to be applied to the substrate, i.e. a low coat weight.

The wet-film thickness must therefore be as constant as possible over the entire web surface. The basic precondition for this is a uniform distribution of the coating fluid over the outlet width with regard to the volume flow and the velocity. This requirement is particularly difficult to meet in the case of large coating widths of, for example, 8 to 10 m and low coating weights of, for example, 2 to 10 g/m². Fluctuating operating conditions, such as large ranges of variation with regard to the viscosity of the coating colour and the coating quantities, constitute an additional requirement during the achievement of a uniform distribution of the wet-film.

In order to achieve the most homogeneous possible distribution in the event of a large variation in the volume flows and the material parameters, a distributor system having two cavities, what is known as the side-fed dual cavity die, is additionally known, cf. Stephan F. Kistler, Peter M. Schweizer, Liquid Film Coating, Scientific Principles and their Technological Implications, Chapman & Hall, New York 1997, pages 752 to 767. Following the distribution in a first cavity, the coating fluid (compound) is led through a first metering slot into a second cavity. The metering slot must produce a high flow resistance. The pressure resulting from this in the first cavity is substantially higher than the transverse pressure loss in the direction of flow. The pressure differences in the flow direction of the first cavity are very low as compared with the total pressure in the first cavity. The pressure distribution and therefore the distribution of the volume flow density over the metering slot are, as a result, approximately uniform in the event of large variations in the volume flows and the material parameters. The remaining deviations are equalized in the second cavity. In order that a high flow resistance is produced, the metering slot must be produced within small dimensions, which lie within the range from 200 to 500 μm. The volume flow deviations over the outlet width must not exceed a scattering range of 1 to 2%. For this purpose, the flat parts which form the metering slot must be fabricated with a deviation from parallelism in a range from ±1 to 3 μm. The length of the metering slot is normally 20 to 40 mm. The effort for fabrication of flat parts with such dimensions with the required precision, in particular in the case of large coating widths of 10 to 12 metres, is very large and associated with considerable costs.

DE 197 55 625 A1 discloses a curtain coater in which the hopper is composed of two wall-like parts which have a length corresponding to the desired coating width. Machined into one long side of one of the parts is a longitudinal groove which, following the joining of the two parts, forms a cavity. Connected to the cavity is an outlet channel extending over the coating width, from which the coating colour emerges. In order to be able to apply even small quantities of coating colour to paper or board webs of great width under fluctuating conditions, for example fluctuating viscosity or changing coating quantities, uniformly and without problems over the coating width, the flow conditions in the cavity are influenced by the volume flows fed in. For this purpose, at least two feed channels are connected to the cavity, each of which has a device for adjusting the volume flow of coating colour fed in. Tube-pinch or diaphragm valves are preferably used for the volume flow adjustment. The volume flows of each feed channel are therefore adjusted separately. For further evening, a second cavity is arranged between the cavity and the outlet channel. Between the then first cavity and the second cavity there is an additional flow channel. The tube-pinch valves and the diaphragm valves are preferred for the volume flow adjustment, in order to avoid deposits of coating pigments. The guide channels are connected to the cavity so as to be inclined with respect to the vertical in the direction of the lateral edge, in order to minimize the space required for the feed channels. The boundary wall of the feed channels is implemented with large radii of the deflection, in order to avoid separation of the flow on the walls and therefore the de-mixing of the coating colour.

The widening of the feed channel is intended to be configured in such a way that the velocity distribution of the channel flow exhibits high symmetry and reverse flows are avoided. The widening angle must therefore lie below a critical value. Given a low viscosity of the coating colour, the widening angle is relatively small, for example 8 to 12°. With a high viscosity, the feed channels can be implemented with a large widening angle, for example 20 to 25°. The disadvantage with this solution is that the distance between the feed channels and the dimensions of the feed channels have to be chosen to be large. The connection spacing of the feed channels lies in the range from 100 to 1500 mm, preferably between 500 and 800 mm. Given smaller spacings, additional control elements are needed, which increase the costs for the curtain coater considerably. A further disadvantage is that the feed channels take up a very great deal of space, in particular in the case of small widening angles, which means that the technical implementation, in particular on the slide dies, is impossible, since the space which is available for this purpose is very limited by the curtain height.

WO 2005/024132 discloses a nozzle unit which has feed holes whose cross sections and whose flow resistances can be varied. As a result, the volume flow in each hole can be regulated. The feed holes are arranged between a machine-width feed chamber and a compensating chamber and are positioned at a distance from one another in a direction over the outlet width. Although this design has a low requirement for space, for this purpose it has the disadvantage that the feed holes have to be positioned at very small distances from one another in order to achieve optimum flow conditions in the machine-width feeding chamber, where the individual partial flows from the feed holes are combined again. The feed holes accordingly have to be dimensioned to be very small. The danger of blockages is then particularly high, however, and absolutely undesired, since production disruptions can be caused.

The object of the invention is, therefore, to provide a curtain coater which ensures high uniformity of the distribution of a coating (application) medium over an outlet width under fluctuating operating conditions with regard to the volume flows and the viscosity of the coating medium and, in the process, can be produced cost-effectively.

This object is achieved by the features of claim 1.

According to the invention, the influencing of the volume flow and the production of a uniform velocity profile in a machine-width outer slot take place separately from each other in two different functional elements. Here, the space required is low, so that the solution according to the invention can also be applied to slide dies.

The adjustable influence on the volume flow is a volume influence that can be adjusted zone by zone, for which purpose a separate device is provided which connects at least two feed channels to a cavity which is subdivided along a discharge width, at least in some regions, into sections and which forms an intermediate chamber. For the production of a uniform velocity profile in the outer slot (flow gap), a diffuser block is provided, which is composed of a large number of guide channels. The number of divisions of the intermediate chamber subdivided into sections in order to influence the volume flow zone by zone is smaller than the number of divisions of the guide channels of the diffuser block.

From this there follow different pitches for the influencing of the volume flow, on the one hand, and the influencing of the velocity profile, on the other hand, the respective pitch of the intermediate chamber preferably being an integer multiple of a pitch of the diffuser block. According to the invention, the (inner) metering slot is replaced here by a large number of guide channels, in order in this way to achieve evening of the velocity profile. Each guide channel can comprise a tube section, which is preferably a part having a circular cross section, and a widening of the channel flow that follows in the flow direction, what is known as the diffuser of the guide channel. The guide channels produce an approximately equal flow resistance.

Further refinements of the invention can be gathered from the following description and the subclaims.

### BRIEF DESCRIPTION OF THE DRAWINGS

The invention will be explained in more detail below by using the exemplary embodiments illustrated in the appended figures, in which:

FIG. 1 shows, schematically, a cross-sectional view of a hopper of a curtain coater for a slide die according to a first exemplary embodiment,

FIG. 2 shows, schematically, a section of a hopper in the cross flow direction of the coater according to A-A according to FIG. 1,

FIG. 3 shows, schematically, a section of a hopper in the cross flow direction of the coater according to a second exemplary embodiment,

FIG. 4 shows, schematically, a cross-sectional view of a hopper of a curtain coater for a slide die according to a third exemplary embodiment,

FIG. 5 shows, schematically, a cross-sectional view of a hopper of a curtain coater for a slot die according to a fourth exemplary embodiment.

### DETAILED DESCRIPTION OF THE INVENTION

The invention relates to a curtain coater for discharging coating (application) medium in the form of a curtain moving substantially under the force of gravity onto a moving paper or board web.

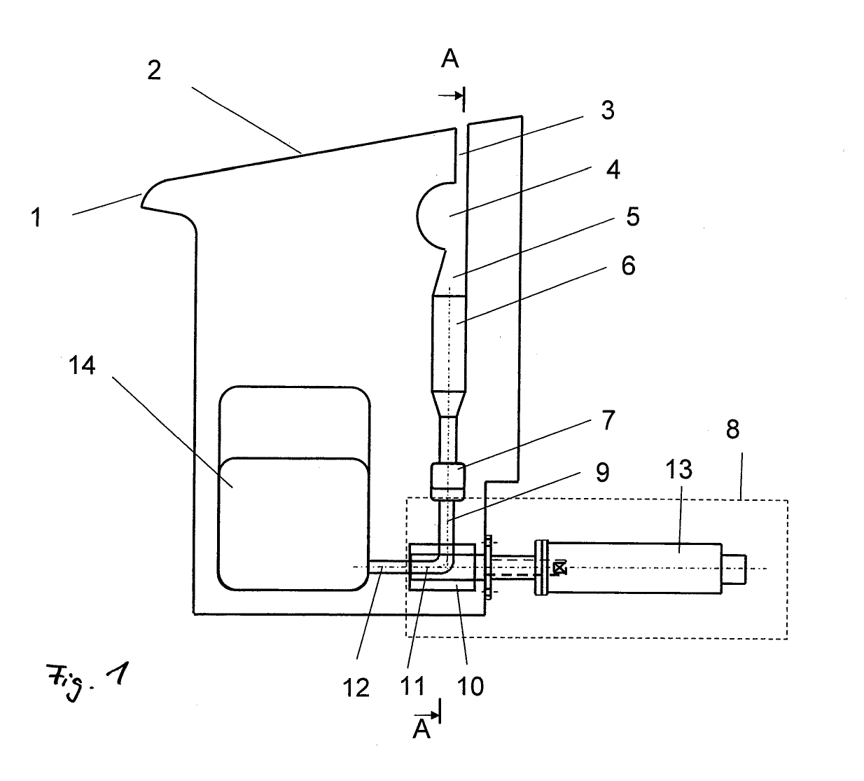

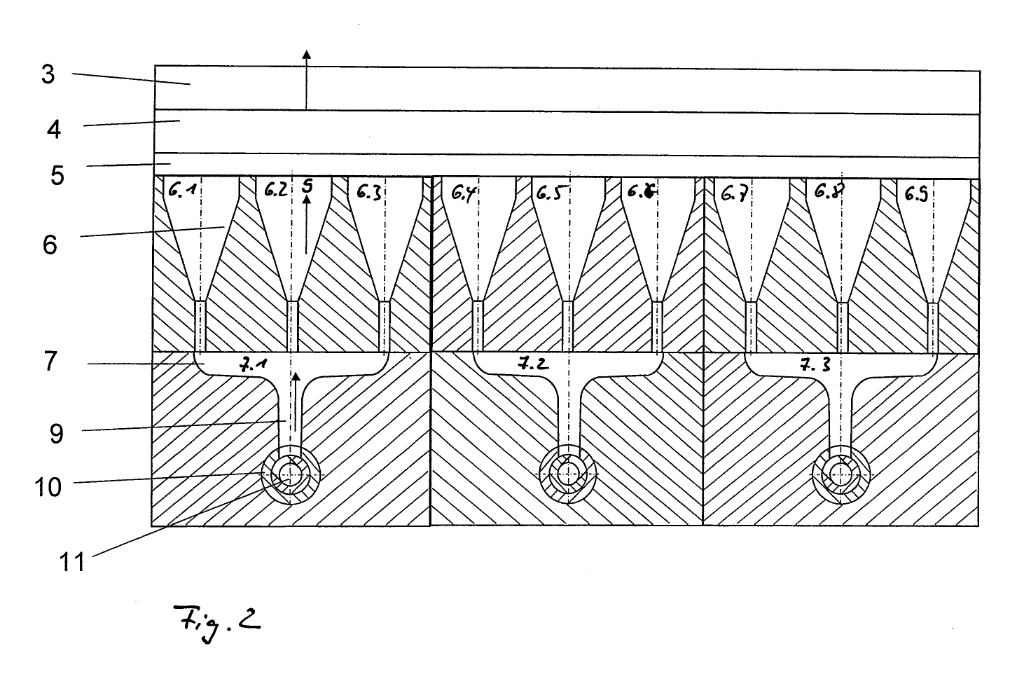

As FIGS. 1 and 2 show, the curtain coater comprises a hopper (nozzle body) 1, whose upper surface in the case of a slide die forms a feed lip 2. The coating medium emerging from an outer slot 3 flows over the feed lip 2 in order to reach the surface of the paper or board web to be coated, which moves under the coating device. The outer slot 3 forms the end section of a flow channel 6, which discharges the coating medium via the outer slot 3 as a flowing or falling curtain.

The hopper 1 comprises a machine-width feed chamber 14, which extends along a discharge width. This feed chamber 14 supplies at least two feed lines 12, which feed the coating medium to a (inner) cavity 7 extending along a discharge width. The feed lines 12 in each case have a device for adjusting the volume flow of coating medium fed in. This device is preferably in each case a valve 16, an actuating cylinder 11 and an actuating motor 13.

The cavity 7 belongs to a device 8 for influencing the volume flow and, along the discharge width, is subdivided, at least in some regions, into sections 7.1, 7.2, 7.3. Each of these sections 7.1, 7.2, 7.3 is connected to a feed line 12. The number of sections can be chosen as 7.1 to 7.n.

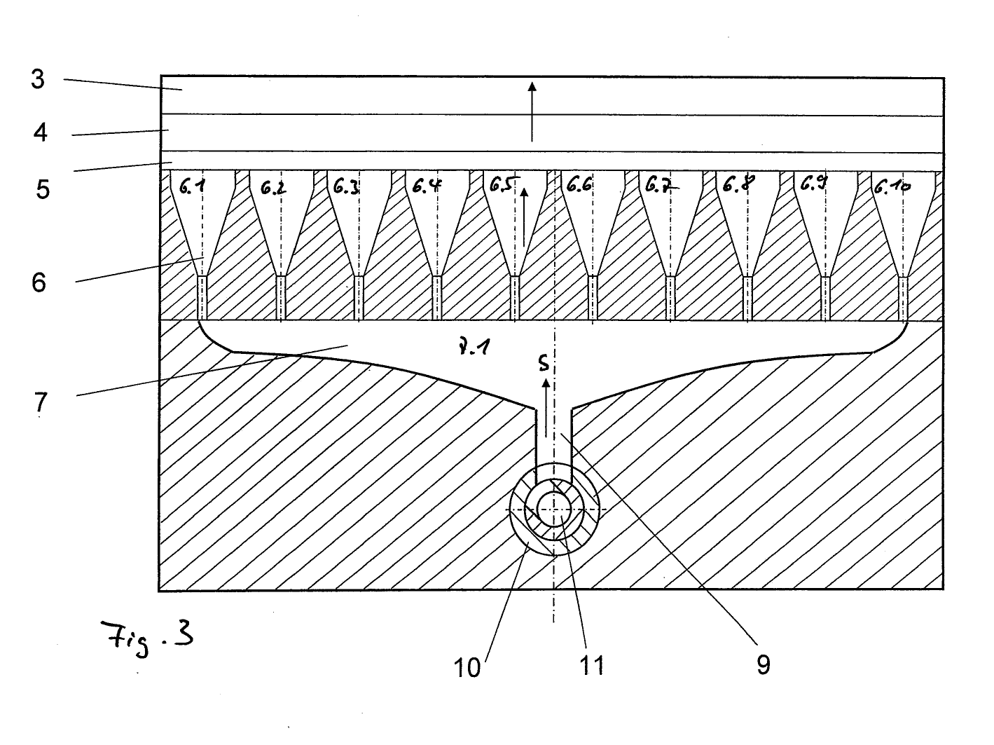

The flow channel 6 is broken down into a large number of individual widening guide channels 6.1, 6.2, 6.3, 6.4, 6.5, 6.6, 6.7, 6.8, 6.9 of a diffuser block which, on the inlet side, adjoin the cavity 7. The cavity 7 with its sections 7.1, 7.2, 7.3 forms an intermediate chamber, which feeds the partial flows supplied by the device 8 for influencing the volume flow zone by zone to the individual guide channels 6.1, 6.2, 6.3, 6.4, 6.5, 6.7, 6.8, 6.9. There is a graduation present, the number of divisions for the cavity 7 being different from that for the flow channel 6. The number of divisions for the cavity 7 is smaller than that for the flow channel 6. From this, it follows that the sections 7.1, 7.2, 7.3 of the cavity 7 each have a pitch which spans a plurality of guide channels 6.1, 6.2, 6.3, 6.4, 6.5, 6.6, 6.7, 6.8, 6.9 of the diffuser block. According to FIG. 2, the sections 7.1, 7.2, 7.3 in each case span three guide channels 6.1, 6.2, 6.3 and 6.4, 6.5, 6.6 and 6.7, 6.8, 6.9, respectively. According to FIG. 3, the section 7.1 spans ten guide channels 6.1, 6.2, 6.3, 6.4, 6.5, 6.6, 6.7, 6.8, 6.9, 6.10.

For the influencing of the volume flow, which can be adjusted zone by zone, a separate device 8 is therefore provided which, in the cross flow direction, is subdivided into a plurality of sections 7.1 to 7.n. For the production of a uniform velocity profile in the outer slot 3, the flow channel 6 is constructed as a diffuser block, which comprises a large number of guide channels 6.1 to 6.n.

The pitch of the sections 7.1 to 7.n is preferably considerably greater than the pitch of the guide channels 6.1 to 6.n and, particularly preferably, corresponds to an integer multiple of the pitch of the guide channels 6.1 to 6.n. As a result, the distance between the guide channels 6.1 to 6.n (zone width) can be chosen to be large, in order to reduce the number of control elements as compared with the prior art and, accordingly, to keep the investment costs low. The connection spacing between two of the guide channels 6.1 to 6.n in each case can be chosen in the range between 15 and 300 mm, preferably 20 and 50 mm.

The pitches of the sections 7.1 to 7.n and guide channels 6.1 to 6.n can be chosen in a ratio of from 2 to 10 to 3 to 5. The sectioned implementation of the cavity 7 is preferably provided over the machine width.

Each of the sections 7.1 to 7.n is connected to a feed line 12, via preferably one valve 10, and as a result connected to the feed chamber 14. In order to minimize the space required, the valve 10 preferably has an actuating cylinder 11 that can be rotated about its own axis and has an L-shaped flow channel, which deflects the flow through 90°. The actuating cylinder 11 is adjusted by the actuating motor 13.

The feed chamber 14 is fed with the coating medium via at least one line (not shown). The flow direction of the coating medium to be fed in starts from the feed chamber 14, as illustrated in FIG. 1. The hopper preferably further comprises a further outer cavity 4, which discharges the coating medium via the outer slot 3 as a curtain.

As FIG. 2 and FIG. 3 show, the guide channels 6.1 to 6.n are designed in such a way that, on the inlet side and along the discharge width, they are connected to the sections 7.1 to 7.n of the cavity 7 by pipe sections spaced apart from one another. The lengths and opening widths of the pipe sections can be chosen in order to even out the flow resistance along the discharge width. In the flow direction S, the pipe sections each merge into a diffuser for the partial flows from the guide channels 6.1 to 6.n to be combined on the outlet side. Between the ends on the outlet sides of the diffusers of the guide channels 6.1 to 6.n and the outer cavity 4, a remaining part of the height of the flow channel can further be formed in the shape of a machine-width metering slot 5, in order to combine the individual partial flows from the individual guide channels 6.1 to 6.n again before the entry into the outer cavity 4. The guide channels 6.1 to 6.n, which are spaced apart and widen, are preferably arranged in a base body of the hopper 1.

The guide channels 6.1 to 6.n extend from the sectioned cavity 7 at right angles to the cross flow direction of the coater, i.e. preferably at right angles to the cross-machine direction (CD) of the moving paper or board web. To this end, the guide channels 6.1 to 6.n are preferably arranged in a line. This is preferably true in the same way of section channels 9 belonging to the device 8 for influencing the volume flow, via which the sectioned cavity 7 is connected to the feed lines 12. Each section 7.1 to 7.n is preferably connected to a section channel 9, which is fed with coating medium via a feed line 12, the volume flow fed in being adjustable by the respective valve 10. Consequently, a corresponding number of section channels 9 and feed lines 12 are also provided in accordance with the number of sections 7.1 to 7.n.

The flow resistances of the guide channels 6.1 to 6.n along the discharge width are substantially equal and are at least 1 mWC (9.81 kPa). The pipe sections of the guide channels 6.1 to 6.n preferably have a circular cross section. The number of guide channels 6.1 to 6.n per metre of the discharge width or outlet width is optional. The number of guide channels preferably lies in the range between 3 and 66. In order to counteract edge flows, it is advantageous to configure the distance between the guide channels variably over the outlet width. From fluid mechanics points of view, it is advantageous to configure the guide channels 6.1 to 6.n in such a way that, in their end region as seen in the flow direction S, they have a blunt end with a top width of less than 0.3 mm or a rounded end, in order to avoid the formation of undesired vortex separations at the end edges.

The widening of the guide channels 6.1 to 6.n is preferably configured such that the velocity distribution of the diffuser flow exhibits high symmetry and reverse flow is avoided. On account of the high viscosity of the coating compound and comparatively low velocity, this is a divergent Jeffery-Hamel flow. The widening angle is preferably less than 25°, specifically between the axis of the diffuser and the wall (bisector).

The parts of the curtain coater touched by the flow are stressed mechanically and chemically. It is therefore advantageous to form the guide channels 6.1 to 6.n in individual modules which, for example, comprise 2 to 10, in particular 3 to 5, guide channels 6.1 to 6.n. As a result, the modules can be replaced more easily in order to carry out adaptation to a changed operating window, for example.

Pressure losses are produced in the device 8 for influencing the volume zone by zone and in the guide channels 6.1 to 6.n. The pressure loss through the valve 10 of the device 8 is preferably greater than the flow resistance through one of the guide channels 6.1 to 6.n, whose pipe sections on the inlet side likewise form restrictors. Distribution of the pressure losses is preferred, at least 50%, preferably up to 75%, of the sum of the two flow resistances being assigned to the throttling points of the device 8. The pressure losses in the region in which the volume flow is influenced zone by zone are thus preferably greater than the pressure losses in the region in which the velocity profiles of the flow are evened out. The valves 10 in each case produce a pressure loss in a partial flow, which widens into a chamber width corresponding to the pitch.

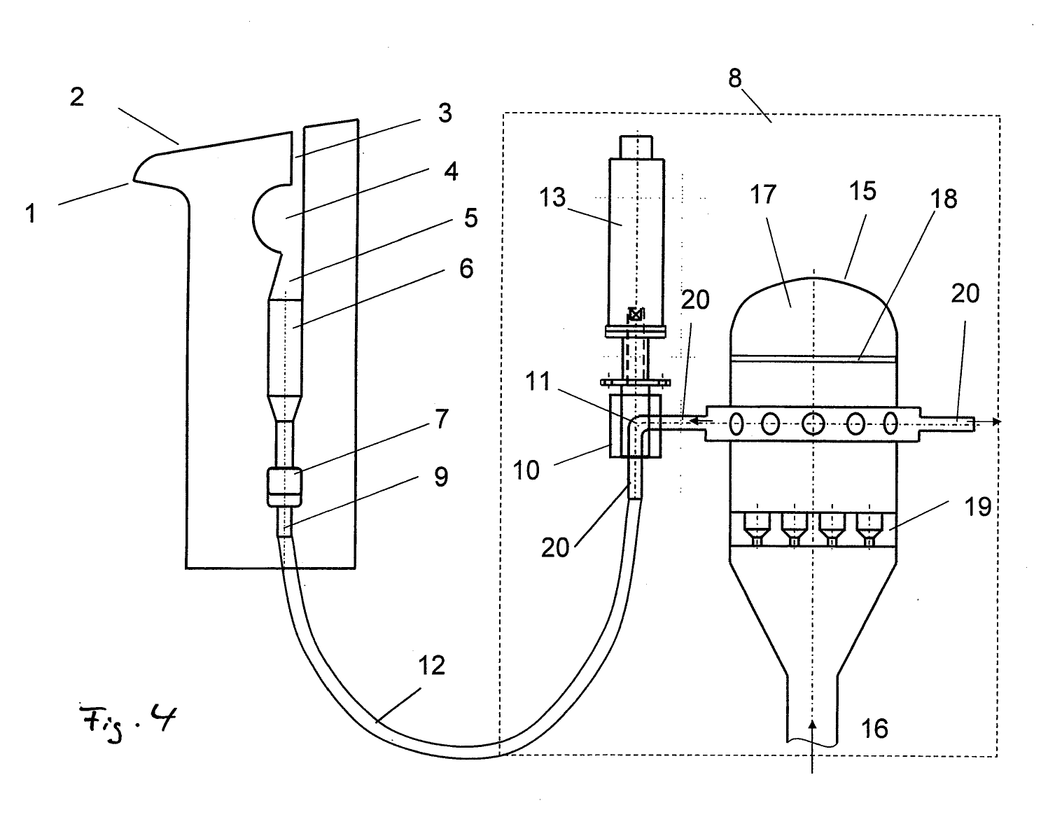

As FIG. 1 shows, the feed chamber 14 can be implemented as a cross flow distributor. As FIG. 4 shows, alternatively an upright radial distributor 15 having a central feed 16 and outgoing connectors 20 arranged radially can also be provided. The radial distributor 15 can have a pulsation damper with air pad 17 and a diaphragm 18 with perforated plate 19 in a known way. The radial distributor 15 is connected to the section channels 9 via flexible feed lines 12 on the outgoing connectors 20.

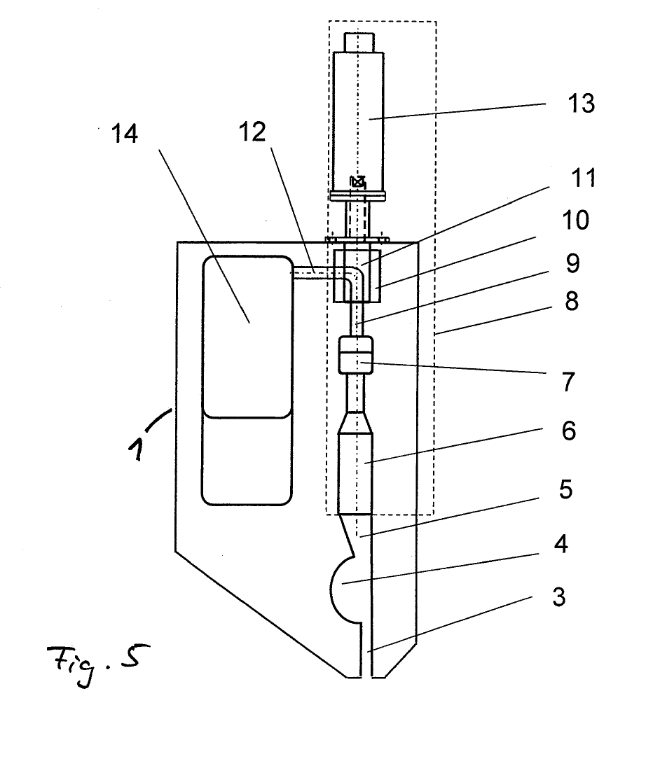

FIG. 5 shows a hopper 1 which is designed as a slot die. The above explanations apply in a corresponding way here, since the hopper (nozzle body) 1 described in accordance with the invention can be used for curtain coating by the slide-type method or a slot-type method.

All publications and patent applications mentioned in this specification are herein incorporated by reference to the same extent as if each individual publication or patent application was specifically and individually indicated to be incorporated by reference.

The invention now being fully described, it will be apparent to one of ordinary skill in the art that many changes and modifications can be made thereto without departing from the spirit or scope of the appended claims.

1. Curtain coater for discharging coating medium in the form of a curtain moving substantially under the force of gravity onto a moving paper or board web, comprising a hopper, which has a cavity extending along a discharge width, to which the coating medium is fed via at least two feed lines which each have a device for adjusting the volume flow of coating medium fed in, and a flow channel which discharges the coating medium via an outer slot as a curtain, wherein the flow channel is broken down into a large number of individual widening guide channels of a diffuser block which, on the inlet side, adjoin a cavity subdivided along the discharge width, at least in some regions, into sections, each of these sections being connected to a feed line and having a pitch which spans a plurality of guide channels of the diffuser block.

2. Curtain coater according to claim 1, wherein the guide channels of the diffuser block are arranged at right angles to the sectioned cavity.

3. Curtain coater according to claim 1, wherein the ratio of the pitch of the sections of the cavity to the pitches of the guide channels lies in the range from 2 to 10 to 3 to 5.

4. Curtain coater according to claim 1, wherein the sections of the cavity each have on the inlet side a section channel for forming a partial flow producing a pressure loss, which partial flow widens into a chamber width corresponding to the pitch.

5. Curtain coater according to claim 4, wherein the pressure losses in the valves are greater than in the guide channels.

6. Curtain coater according to claim 1, wherein the guide channels have individual pipe sections spaced apart from one another on the inlet side, which each merge into a widening section for the partial flows from the guide channels to be combined on the outlet side.

7. Curtain coater according to claim 6, wherein the lengths and opening widths of the pipe sections of the guide channels can be chosen in order to even out the flow resistance along the discharge width.

8. Curtain coater according to claim 1, wherein a outer cavity is provided, which discharges the coating medium via the outer slot as a curtain, and the flow channel is arranged between the cavity and the outer cavity.

9. Curtain coater according to claim 1, wherein the flow resistances of the guide channels along the discharge width are substantially equal and are at least 1 mWC.

10. Curtain coater according to claim 1, wherein the guide channels are arranged in a line.

11. Curtain coater according to claim 1, wherein the widening angle of the walls of the respective guide channel that bound the flow is chosen as a function of the volume flow, density and dynamic viscosity of the respective coating medium.

12. Curtain coater according to claim 1, wherein the guide channels are formed as replaceable modules which have a plurality of guide channels.

13. Curtain coater according to claim 1, wherein a machine-width feed chamber is implemented as a cross flow distributor.

14. Curtain coater according to claim 1, wherein a radial distributor having outgoing connectors arranged radially is connected to the feed lines.
